(19) United States
(12) Patent Application Publication
(10) Pub. No.: US 2017/0002209 A1
(43) Pub. Date: Jan. 5, 2017

(54) Aqueous Compositions for Primary Anti-Adhesive Coating and Preparation Method Thereof

(71) Applicant: SEB S.A., Ecully (FR)

(72) Inventors: Barbara Gantillon, Leschaux (FR); Jean-Luc Perillon, Saint Paul Trois Chateaux (FR)

(21) Appl. No.: 15/105,433

(22) PCT Filed: Dec. 16, 2014
(86) PCT No.: PCT/FR2014/053368

§ 371 Date: Jun. 16, 2016

(30) Foreign Application Priority Data
Dec. 20, 2013 (FR) 1363355

(51) Int. Cl. C09D 5/00; B05D 7/00; B05D 3/02; B05D 5/08; C09D 179/08; C09D 127/18

(52) U.S. Cl. CPC C09D 5/002; C09D 179/08; C09D 127/18; B05D 3/0254; B05D 5/083; B05D 7/542; B05D 2202/00; B05D 2518/12; B05D 2505/50; B05D 2506/10

(57) ABSTRACT

Provided is an aqueous composition including a polyimide or a polyamide-imide or a polyamide-amidic acid, as well as a Lewis base, a polar aprotic solvent, and at least 15% water compared to the total weight of said composition, wherein the Lewis base is an aminosilane or a silazane.

The present invention relates in a general manner to aqueous compositions (or semi-finished compositions) for fluorocarbonated resin based primary anti-adhesive coating. The present invention also relates to a method of preparing such a composition, a primary anti-adhesive coating composition incorporating such a composition, a method of preparing such a primer composition, as well as a method of manufacturing an item comprising a metal substrate to which such a primer composition is applied.

Anti-adhesive coatings based on polytetrafluoroethylene (PTFE) are widely used in the cookware field. They are formed from at least one layer containing the perfluorinated resin and a bonding resin. This primer layer is then coated with one or more PTFE layers in which the amount of PTFE is gradually increased.

The bonding resins enabling this primer and the other fluorinated layers to stick to the base are generally polyamide-imide (PAI), polyphenylene sulfide (PPS), polyethersulfone (PES), and polyether ether ketone (PEEK) resins.

In the specific case in which obtaining light-colored primers is desired, preference is given to PES, PPS or PEEK resins.

However, these resins are not easy to work with because they are not easily dissolved other than in polar aprotic solvents, most of which are subject to labeling as hazardous or even toxic products under the REACH regulation. These resins can be used in powder form in practice. However, obtaining powders of small particle size is difficult and expensive, in turn making it difficult to grind these polymers to a size less than d50=10 μm. As a result, the distribution of these resins in the primer layer is not homogeneous and leads to adhesion losses during use.

In this respect, PAI resins that are supplied as solutions or water-thinnable powders are easier to work with. However, they incorporate large amounts of solvent. The need of using N-ethylpyrrolidone (NEP), N-methylpyrrolidone (NMP), and dimethyl ethylene urea (DMEU) polar aprotic solvents leads to impacts on the environment and on health that are significant.

When they are supplied as water-thinnable powders, the constraint linked to solvent use no longer applies, but these PAI resins also exhibit less than adequate heat stability. Indeed, during the PTFE sintering step (carried out at temperatures hotter than 370° C. and preferably at 415° C.), a small fraction of PAI resin decomposes, which is a disadvantage even if this phenomenon has no effect on the majority of the properties of the coating obtained. Furthermore, using a labile amine to enable the use of the PAI resin in liquid phase causes a significant fraction of volatile organic compounds to be generated when working in an aqueous medium, which induces an unacceptable yellowing of the coating obtained.

On the other hand, the preparation of polyamic acid-grafted silica is known to the prior art (Peng Liu, Iranian polymer Journal 14, (11) 2005, 968-972). While these grafted silicas exhibit improved temperature-dependent behavior, the starting compound is an already-existing silica on the one hand, and all of the modifications of the silica are performed in a solvent medium on the other hand. The use of these silicas in solvent media is implied (also see conclusion), which does not resolve the environmental constraints problem.

Patent documents EP 0386379 and FR 2625450 of Corning Glass Works both describe mixtures of PAI and an aminosilane in a similar manner. In the procedure described, the aminosilane is mixed with the PAI precursor already in aqueous solution; in other words, the PAI precursor already incorporates an amine for salification as well as (in view of the choice of PAI described in the examples) a solvent, this solvent being necessary for preparing the liquid mixture.

These patent documents are therefore neither exempt from the presence of the volatile amine likely to cause yellowing nor from the presence of potentially toxic polar aprotic solvent.

For remedying these disadvantages, the applicant developed an aqueous composition based on a polyimide or a polyamide-imide or a polyamide-amic acid, and containing an aminosilane or a silazane.

The utilization of an aminosilane or a silazane makes it possible to obtain a polyamide-amic acid polyelectrolyte in aqueous emulsion without using highly nucleophilic compounds such as amines, which will oxidize and which will lead to the formation of very yellowing coatings. In addition to the reduction of yellowing, other properties of the coating obtained are noticeably improved as well.

This also makes it possible to create a hybrid by “curing on” the PAI resin by means of silanols. This is possible because the aminosilane is, in a manner of speaking, pre-distributed on the PAI chain. Furthermore, this also makes it possible to improve the resistance of the coating thus obtained to abrasion by generating silica nanodomains in the formula, which are obtained by the silanols condensing among each other. This also makes it possible to obtain a clearly reinforced thermal stability of the nanofilled polymer film. Thermal stability can be measured, for example, by observing a glass transition temperature shift of at least 20° C. and a shift of the thermal degradation curve under nitrogen by 40° C. at the minimum between a standard semi-finished product and a semi-finished product of the invention.

This nanofilled PAI film exhibits good adhesion to the metal substrate, which is furthermore greatly improved due to a portion of the silanols bonding with the metal base.

The polymer such as PAI, and even more so in the case of a polyamide-amic acid polymer, contains many reactive terminal groups, in particular ones such as carboxylic and amide groups, which will be able to react with the nitrogenous reactive group of the aminosilane or of the silazane. The PAI dissolved in a polar aprotic solvent (NEP, NMP, DMEU, dimethyl sulfoxide (DMSO), etc.) or in wet powder form in water is emulsified in the water by reacting with the aminosilane or the silazane. During this process, the aminosilane or silazane clusters graft themselves to the PIA chain via their NH₂ and NH terminal groups, respectively. It is also possible for a portion of the aminosilanes to graft themselves directly onto the polyamide-amic acid by their alkoxy (methoxy or ethoxy or silanol) clusters. When the aqueous solution is made up and given the local acidity of the medium due to the presence of still-free carboxylic groups, a hydrolysis of the alkoxysilane clusters into silanols is observed, thus further reinforcing the compatibilization with water. If necessary, the formulation is completed with an alkoxysilane mixture. During the kilning of the composition and after evaporation of the water and alcohols, the curing of the whole is effected by a sol-gel type condensation reaction that creates an array of silica nanofillers in the PAI organic matrix and by a cyclization of the imide clusters. This makes it possible to obtain an organic-inorganic hybrid structure with the formation of a perfectly dispersed nanometric silica array in the PAI matrix.

The object of the present invention is therefore more particularly an aqueous composition (or semi-finished composition) comprising a polyimide or a polyamide-imide or a polyamide-amic acid as well as a Lewis base, a polar aprotic solvent, and at least 15% water compared to the total weight of said composition, characterized in that the Lewis base is an aminosilane or a silazane.

Advantageously, the aminosilane or the silazane is present in said composition at a concentration of 0.1 to 10% by weight compared to the total weight of said composition.

Advantageously, the aminosilane is 3-aminopropyltriethoxysilane (APTES).

Advantageously, the silazane is hexamethyldisilazane.

Advantageously, the polar aprotic solvent is present at a concentration of 1 to 70% by weight compared to the total weight of the composition.

Advantageously, the polar aprotic solvent is N-ethylmorpholine, N-ethylpyrrolidone, or dimethyl sulfoxide.

A further object of the present invention is a primary anti-adhesive coating composition comprising an aqueous composition according to the invention as defined above and a fluorocarbonated resin dispersion.

The fluorocarbonated resin can be chosen from the group comprising polytetrafluoroethylenes (PTFE), copolymers of tetrafluoroethylene and perfluoro(propyl vinyl ether) (PFA), copolymers of tetrafluoroethylene and hexafluoropropylene (FEP), polyvinylidene fluorides (PVDF), MVA (copolymer of TFE/PMVE), the terpolymers TFE/PMVE/FAVE, ETFE, and mixtures thereof.

Preference is given to using polytetrafluoroethylene (PTFE) or a mixture (PTFE/PFA) of polytetrafluoroethylene (PTFE) and copolymers of tetrafluoroethylene and perfluoro(propyl vinyl ether) (PFA), or a mixture (PTFE/FEP) of polytetrafluoroethylene (PTFE) and copolymers of hexafluoropropylene and tetrafluoroethylene (FEP).

A further object of the present invention is a method of preparing an aqueous composition (or semi-finished composition) according to the invention, comprising the following steps:
a) a polyimide or polyamide-imide or polyamide-amic acid polymer is dissolved in a polar aprotic solvent to form a homogeneous mixture;
b) a Lewis base is introduced into said mixture for fixing said base on said polymer, and
c) water is added to the mixture thus formed.

Optionally, a second Lewis base that is neither a silane nor a silazane can also be added to the mixture obtained in step c).

A further object of the present invention is a method of preparing a primary anti-adhesive coating composition comprising d) the mixing of an aqueous composition (or semi-finished composition) as defined in the preceding or obtained by the method of preparing an aqueous composition as defined in the preceding with a fluorocarbonated resin.

Optionally, fillers and/or pigments can be added to the mixture of the aqueous composition and the fluorocarbonated resin dispersion.

A further object of the present invention is a method of manufacturing an item, comprising the following steps:
A. provision of a metal substrate having two opposite sides;
B. application of at least one layer of primary anti-adhesive coating composition as defined in the preceding or obtained by the method of preparing a primer composition as defined in the preceding on one of the sides of said substrate,
C. application of at least one layer of finish composition comprising at least one fluorinated resin on said primer composition layer, then
D. kilning of the whole at a temperature in the range of 370° C. to 430° C.

Lastly, a further object of the invention is an item that can be obtained according to the method of manufacturing an item according to the invention.

An example of such is a cookware item, one of the sides of which constitutes an inside surface intended to be in contact with food put inside said item and the other side of which is a convex outside surface intended to be in contact with a heat source.

### EXAMPLES

Tests

Determination of the Dry Extract of a Semi-Finished or Primary Aqueous Composition

Principle

The dry extract of a product is the residual solid portion remaining after evaporation of the volatile materials that it contains. The drying temperature and drying time play a key role because the solvents with high boiling points, the monomer fractions, the reactive diluents, and the reaction by-products (depending on their degree of retention) very slowly leave the film that forms. Hence, it is very important to define standardized drying conditions in a very conventional way and as close to actual practice as possible.

Procedure

This dry extract is measured as follows:

an aluminum cup is weighed: m₀=weight of the cup;

between 0.5 g and 3 g of the product being studied are placed in this cup:

the filled cup is weighed: m₁=weight of the filled cup;

the cup is placed in a kiln set to 210° C. for two hours;

after kilning and after cooling, the cup is weighed: m₂₌weight of the filled cup after kilning and cooling;

the dry extract is given by the formula (1) below:

Dry extract=100*[(m₂−m₀)/(m₁−m₀)]

Evaluation of the Stability of the viscosity of a primary or semi-finished aqueous composition

The stability of the viscosity of a semi-finished (without PTFE) or primary (with PTFE and fillers) aqueous composition applied by spraying is evaluated by measuring the flow times according to the DIN EN ISO 2433/ASTM 05125 standard by means of a 2.5 flow cup or a 4 flow cup.

The viscosity corresponds to the continuous flow time, expressed in seconds, of the volume of the cup through the calibrated orifice. The cup choice is made on the basis of the assumed viscosity of the product.

The progression of the viscosity is monitored by measuring the continuous flow time of the standardized volume at ambient temperature immediately after preparing the compositions, and by monitoring the progression of this viscosity over time at ambient temperature;

Once formulated, the compositions are placed in a kiln at 40° C.; the progression of the flow time, and thus of the viscosity (evaluation of the stability of the emulsion after ageing at 40° C.), is then monitored over time.

Method and Technique

The PAI resin is introduced in a reactor. The resin can either be in the form of a wet powder (polyamic acid or polyamide-amic acid (PAA) with a hydroxyl index in the range of 40 and 200 meq KOH/g) or in the form of a PAI polymer dissolved in a polar aprotic solvent.

In the case where the PAI resin is in the form of a powder, the powder is preferably solubilized in a preferably non-toxic, even non-classified polar aprotic solvent.

The neutralization reaction of the terminal acid clusters of the PAI or of the PAA with the amine functional group of the aminosilane leads to the use of the PAI resin in aqueous phase or in water +solvent phase. Under these conditions, the condensation of the silanol clusters among each other is reduced. An alkoxysilane is chemically grafted onto a PAI resin in this manner.

Then, in the following phase, the alkoxysilane clusters are progressively hydrolyzed to hydroxylated clusters (silanols), which condense during kilning to form a nanostructured silica array within the polymer matrix.

The resin thus dispersed in aqueous phase or in water mixed with a co-solvent can be used as is in the fluorinated primer formulations.

This mixture remains stable in spite of the alkalinity of the PTFE dispersion, wherein the condensation of silanols, generating a very finely dispersed inorganic phase that is bonded to a greater or lesser extent to the PAI matrix, is only observed during the kilning.

### Example 1

### Comparison SEMI-FINISH SFc1

Preparation of an Aqueous Composition Based on a PAI (Powder) and Triethylamine

A semi-finished aqueous composition SFc1 is prepared that comprises the following compounds, the respective quantities of which are given in g:

| | |
|---|---|
| polyamide-amic acid (35% of the dry extract): | 103.0 g |
| triethylamine: | 21.4 g |
| demineralized water: | 485.0 g |
| TOTAL: | 609.4 g |

The semi-finished aqueous composition SFc1 is prepared as follows:

a water-triethylamine mixture is introduced into a reactor;

the mixture obtained is stirred and then heated to a temperature of 65° C.+/−5° C.;

the polyamide-amic acid powder is then introduced, under stirring, into the mixture;

the mixture thus obtained is maintained under stirring at 65° C. for at least 5 hours and up to 10 hours at the maximum.

The properties of the aqueous composition SFc1 thus obtained are as follows:

theoretical dry extract: 6%

dry extract measured in the composition: 6.3%

The product is translucent, honey-colored, and viscous.

viscosity (in a 4 cup according to the DIN EN ISO 2433/ASTM D5125 standard): 50 sec

after ageing at 40° C., the product forms a gel after only 10 days of storage (no flow, viscosity non-measurable).

### Example 2

### Comparison Semi-Finish SFc2

Preparation of an Aqueous Composition Based on PAI (Powder), Triethylamine, and Colloidal Silica

A semi-finished aqueous composition SFc2 is prepared that comprises the following compounds, the respective quantities of which are given in g:

| | |
|---|---|
| polyamide-amic acid (35% of the dry extract): | 103.0 g |
| triethylamine: | 21.4 g |
| demineralized water: | 485.0 g |
| colloidal silica (30% of the dry extract: | 16.0 g |
| TOTAL: | 625.4 g |

The rate of silica used in this composition leads to a final rate of 11.6% by weight of silica in the dry film compared to the total weight of the dry film.

The semi-finished aqueous composition SFc2 is prepared as follows:

a water-triethylamine mixture is introduced into a reactor;

the mixture obtained is stirred and then heated to a temperature of 65° C.+/−5° C.;

the polyamide-amic acid powder is then introduced, under stirring, into the mixture;

the mixture thus obtained is maintained under stirring at 65° C. for at least 5 hours and up to 10 hours at the maximum.

the mixture obtained is allowed to chill, then the colloidal dispersion of silica ca. 40 to 200 nm in size is introduced into the mixture at ambient temperature.

The properties of the aqueous composition SFc2 thus obtained are as follows:

theoretical dry extract: 6.6%

dry extract measured in the composition: 6.9%

The product is translucent, honey-colored, and viscous.

viscosity (in a 4 cup according to the DIN EN ISO 2433/ASTM D5125 standard): 80 sec

after ageing at 40° C., the product forms a gel after only 10 days of storage (no flow, viscosity non-measurable).

### Example 3

### Semi-Finish SF1 According to the Invention

Preparation of an Aqueous Composition Based on a Polyamide-Amic Acid (PAA) and an Aminosilane (with a Co-Solvent)

The PAA used has terminal clusters of around 200 meq of KOH/g.

A PAA resin marketed by Solvay under the brand name TORLON AI 30LM is used.

The aminosilane used is 3-aminopropyltriethoxysilane in aqueous solution, and in particular the product marketed by DEGUSSA under the brand name Dynasylan AMEO.

The co-solvent used is N-ethylmorpholine or 4-acetylmorpholine (CAS RN: 1696-20-4).

A semi-finished aqueous composition SF1 is prepared, which comprises the following compounds, the respective quantities of which are given in g:

| | |
|---|---|
| polyamide-amic acid (35.5% of the dry extract): | 18.1 g |
| N-ethylmorpholine: | 61.1 g |
| 3-aminopropyltriethoxysilane (APTES) (100%): | 1.1 g |
| demineralized water: | 19.7 g |
| triethylamine: | 0.9 g |
| TOTAL: | 100.9 g |

The rate of silicon provided by the APTES in this composition leads to a final rate of ca. 2% by weight of silicon in the dry film compared to the total weight of the dry film.

The semi-finished aqueous composition SF1 is prepared as follows:

the polyamide-amic acid powder that is solubilized in the unlabeled solvent is introduced into a reactor;

the 3-aminopropyltriethoxysilane (APTES) is then introduced into the mixture, under slow stirring;

the mixture is mechanically stirred for at least 2 hours with a marine propeller mounted on a Rayneri mixer;

a clear and homogeneous solution in the solvent is thus obtained;

the stirring system is then modified: a shear blade is mounted on the Rayneri mixer;

water is then added drop by drop using a dropping funnel with a flow rate of ca. 0.0015 g/min;

a change of the solvent phase to a perfectly dispersed aqueous phase is observed;

an emulsion is obtained: the product is a milky, stable product;

in order to improve the stability of the viscosity of this sol-gel emulsion, a base such as triethylamine is added, making it possible to obtain an ambient stability of several weeks.

The aqueous composition SF1 thus obtained has the following properties:

theoretical dry extract: 6.9%

dry extract measured in the composition: 7.2%

pH=10.4

The product is milky and stable.

viscosity (in a 2.5 cup according to the DIN EN ISO 2433/ASTM D5125 standard): 42 sec

### Example 4

### Semi-Finish SF2 according to the Invention

Preparation of an aqueous composition based on a polyamide-amic acid (PAA) and an aminosilane (with a co-solvent)

The PAA used has terminal clusters of around 200 meq of KOH/g.

A PAA resin marketed by Solvay under the brand name TORLON AI 30LM is used.

The aminosilane used is 3-aminopropyltriethoxysilane in aqueous solution, and in particular the product marketed by DEGUSSA under the brand name Dynasylan AMEO.

The co-solvent used is dimethyl sulfoxide (DMSO), which is an unlabeled solvent.

A semi-finished aqueous composition SF2 is prepared, which comprises the following compounds, the respective quantities of which are given in g:

| | |
|---|---|
| polyamide-amic acid (35.5% of the dry extract): | 18.1 g |
| DMSO: | 61.1 g |
| 3-aminopropyltriethoxysilane (APTES) (100%): | 1.1 g |
| demineralized water: | 19.7 g |
| triethylamine: | 0.9 g |
| TOTAL: | 100.9 g |

The rate of silicon provided by the APTES in this composition leads to a final rate of ca. 2% by weight of silicon in the dry film compared to the total weight of the dry film.

The semi-finished aqueous composition SF2 is prepared as follows:

the polyamide-amic acid powder that is solubilized in the unlabeled solvent is introduced into a reactor;

the 3-aminopropyltriethoxysilane (APTES) is then introduced into the mixture, under slow stirring;

the mixture is mechanically stirred for at least 2 hours with a marine propeller mounted on a Rayneri mixer;

a clear and homogeneous solution in the solvent is thus obtained;

the stirring system is then modified: a shear blade is mounted on the Rayneri mixer;

water is then added drop by drop using a dropping funnel with a flow rate of ca. 0.0015 g/min;

a change of the solvent phase to a perfectly dispersed aqueous phase is observed;

an emulsion is obtained: the product is a milky, stable product;

in order to improve the stability of the viscosity of this sol-gel emulsion, a base such as triethylamine is added, making it possible to obtain an ambient stability of several weeks.

The aqueous composition SF2 thus obtained has the following properties:

theoretical dry extract: 6.9%

dry extract measured in the composition: 7.2%

pH =10.4

The product is milky and stable.

viscosity (in a 2.5 cup according to the DIN EN ISO 2433/ASTM D5125 standard): 42 sec

### Example 5

### Semi-Finish SF3 according to the Invention

Preparation of an Aqueous Composition Based on a Polyamide-Imide (PAI) (with a Co-Solvent) and an Aminosilane

The PAI used is a PAI resin marketed by HUNTSMAN under the brand name RHODEFTAL 210ES, the dry extract of which is 29% in N-ethylpyrrolidone.

The aminosilane used is 3-aminopropyltriethoxysilane in aqueous solution, and in particular the product marketed by DEGUSSA under the brand name Dynasylan AMEO.

A semi-finished aqueous composition SF3 is prepared, which comprises the following compounds, the respective quantities of which are given in g:

| | |
|---|---|
| polyamide-imide (29% of the dry extract): | 24.0 g |
| N-ethylpyrrolidone: | 53.5 g |
| 3-aminopropyltriethoxysilane (APTES) (100%): | 1.2 g |
| demineralized water: | 21.3 g |
| triethylamine: | 0.9 g |
| TOTAL: | 100.9 g |

The rate of silicon provided by the APTES in this composition leads to a final rate of ca. 2% by weight of silicon in the dry film compared to the total weight of the dry film.

The semi-finished aqueous composition SF3 is prepared as follows:

the polyamide-imide that is diluted into the N-ethylpyrrolidone is introduced into a reactor;

the 3-aminopropyltriethoxysilane (APTES) is then introduced into the mixture, under slow stirring;

the mixture is mechanically stirred for at least 2 hours with a marine propeller mounted on a Rayneri mixer;

a clear and homogeneous solution in the solvent is thus obtained;

the stirring system is then modified: a shear blade is mounted on the Rayneri mixer;

water is then added drop by drop using a dropping funnel with a flow rate of ca. 0.0015 g/min;

a change of the solvent phase to a perfectly dispersed aqueous phase is observed;

an emulsion is obtained: the product is a milky, stable product;

in order to improve the stability of the viscosity of this sol-gel emulsion, a base such as triethylamine is added, making it possible to obtain an ambient stability of several weeks.

The aqueous composition SF3 thus obtained has the following properties:

theoretical dry extract: 7.42%

dry extract measured in the composition: 7.6%

pH=10.4

The product is milky and stable.

viscosity (in a 2.5 cup according to the DIN EN ISO 24331 ASTM 05125 standard): 45 sec

### Example 6

### Semi-Finish SF4 According to the Invention

Preparation of an Aqueous Composition Based on a Polyamide-Amic Acid (PAA) and a Silazane (with a Co-Solvent)

The PAA used has terminal clusters of around 200 meq of KOH/g.

A PAA resin marketed by Solvay under the brand name TORLON AI 30LM is used.

The silazane used is hexamethyldisilazane, with a molar mass of 161.39 g/mol.

The co-solvent used is N-ethylmorpholine (or 4-acetylmorpholine) (CAS RN: 1696-20-4).

A semi-finished aqueous composition SF4 is prepared, which comprises the following compounds, the respective quantities of which are given in g:

| | |
|---|---|
| polyamide-amic acid (35.5% of the dry extract): | 18.1 g |
| N-ethylmorpholine: | 61.1 g |
| hexamethyldisilazane (100%): | 1.1 g |
| demineralized water: | 19.7 g |
| triethylamine: | .9 g |
| TOTAL: | 100.9 g |

The rate of silicon provided by the APTES in this composition leads to a final rate of ca. 3% by weight of silicon in the dry film compared to the total weight of the dry film.

The semi-finished aqueous composition SF4 is prepared as follows:

the polyamide-amidic acid powder that is solubilized in the unlabeled solvent is introduced into a reactor;

the hexamethyldisilazane is then introduced into the mixture, under slow stirring;

the mixture is mechanically stirred for at least 2 hours with a marine propeller mounted on a Rayneri mixer;

a clear and homogeneous solution in the solvent is thus obtained;

the stirring system is then modified: a shear blade is mounted on the Rayneri mixer;

water is then added drop by drop using a dropping funnel with a flow rate of ca. 0.0015 g/min;

a change of the solvent phase to a perfectly dispersed aqueous phase is observed;

an emulsion is obtained: the product is a milky, stable product;

in order to improve the stability of the viscosity of this sol-gel emulsion, a base such as triethylamine is added, making it possible to obtain an ambient stability of several weeks.

The aqueous composition SF4 thus obtained has the following properties:

theoretical dry extract: 6.9%

dry extract measured in the composition: 7.2%

pH=10.4

The product is milky and stable.

viscosity (in a 2.5 cup according to the DIN EN ISO 2433/ASTM D5125 standard): 39 sec

### Example 7

### Comparison Primer Pc1

Preparation of a Fluorinated Primer Pc1 from the Semi-Finish SFc1

A fluorinated aqueous primer composition is prepared from the semi-finish SFc1 and comprises the following compounds, the respective quantities of which are given in g:

| | |
|---|---|
| colloidal dispersion of PTFE (60% of the dry extract): | 289.3 g |
| carbon black (25% of the dry extract in water): | 40.8 g |
| colloidal silica (30% of the dry extract in water): | 164.6 g |
| semi-finish SFc1 (6% of the dry extract in water): | 237.0 g |
| surfactant system (12% of the dry extract in water): | 51.3 g |
| demineralized water: | 421.8 g |
| 3-aminopropyltriethoxysilane (APTES) (100%): | 9.4 g |
| triethylamine: | 2.0 g |
| TOTAL: | 1216.2 g |

The rate of silicon provided by the APTES in this composition leads to a final rate of ca. 0.5% by weight of silicon in the dry film compared to the total weight of the dry film.

The primer composition Pc1 thus obtained has the following properties:

theoretical dry extract: 21.7%

dry extract measured in the composition: 22.4%

pH=8.5

viscosity (in a 2.5 cup according to the DIN EN ISO 2433/ASTM D5125 standard): 65 sec

The product is milky but very unstable and settles out irreversibly.

The post-addition of APTES to a fluorinated primer leads to rapid condensation of the silanol clusters, with irreversible gel formation.

This primer cannot be applied to a base.

### Example 8

### Primer P1 According to the Invention

Preparation of a Fluorinated Primer P1 from the Semi-Finish SF1

A fluorinated aqueous primer composition is prepared from the semi-finish SF1 and comprises the following compounds, the respective quantities of which are given in g:

| | |
|---|---|
| colloidal dispersion of PTFE (60% of the dry extract): | 298.3 g |
| carbon black (25% of the dry extract in water): | 42.1 g |
| colloidal silica (30% of the dry extract in water): | 169.7 g |
| semi-finish SF1 (6.9% of the dry extract in water + NEM): | 213.2 g |
| surfactant system (12% of the dry extract in water): | 53.0 g |
| demineralized water: | 223.7 g |
| TOTAL: | 1000.0 g |

The aqueous mixture thus obtained has the following properties:

theoretical dry extract: 26.2%

dry extract measured in the composition: 25.9%

pH=8.5

viscosity (in a 2.5 cup according to the DIN EN ISO 2433/ASTM D5125 standard): 50 sec

The product obtained is milky and very stable, no change in ambient viscosity greater than 5% after 2 months of storage.

1. An aqueous composition comprising:
a polyimide or a polyamide-imide or a polyamide-amic acid,
a Lewis base,
a polar aprotic solvent, and
at least 15% water compared to the total weight of said composition,
wherein the Lewis base is one of an aminosilane or a silazane.

2. The composition according to claim 1, wherein the aminosilane or the silazane is present in said composition at a concentration of 0.1 to 10% by weight compared to the total weight of said composition.

3. The composition according to claim 1, wherein the aminosilane is 3 aminopropyltriethoxysilane (APTES).

4. The composition according to claim 1, wherein the silazane is hexamethyldisilazane.

5. The composition according to claim 1, wherein the polar aprotic solvent is present at a concentration of 1 to 70% by weight compared to the total weight of the composition.

6. The composition according to claim 1, wherein the polar aprotic solvent is N-ethylmorpholine.

7. A non-stick coating primer composition, comprising an aqueous composition as defined according to claim 1 and a fluorocarbon resin dispersion.

8. The composition according to claim 7, wherein the fluorocarbon resin is chosen from the group comprising polytetrafluoroethylenes (PTFE), copolymers of tetrafluoroethylene and perfluoro(propyl vinyl ether) (PFA), copolymers of tetrafluoroethylene and hexafluoropropene (FEP), polyvinylidene fluorides (PVDF), MVA (copolymer of TFE/PMVE), terpolymers TFE/PMVE/FAVE, ETFE, and mixtures thereof.

9. The composition according to claim 8, wherein the fluorocarbon resin is one selected from the group consisting of polytetrafluoroethylene (PTFE), or a mixture (PTFE/PFA) of polytetrafluoroethylene (PTFE) and copolymer of tetrafluoroethylene and perfluoro(propyl vinyl ether) (PFA), or a mixture (PTFE/FEP) of polytetrafluoroethylene (PTFE) and copolymer of tetrafluoroethylene and hexafluoropropene (FEP).

10. A method for the preparation of a non-stick coating primer composition, comprising the following steps:
a) dissolving a polyimide or polyamide-imide or polyamide-amic acid polymer is dissolved-in a polar aprotic solvent to form a homogeneous mixture;
b) introducing a Lewis base into said mixture of step a) in order to fix said base to said polymer;
c) adding water to the mixture thus formed in step b), and
d) adding a fluorocarbon dispersion to the mixture obtained in step c).

11. A method for the manufacture of an item, comprising the following steps:
A. providing a metal substrate having two opposite sides;
B. applying at least one layer of the primer composition as defined according to claim 7 on one of the sides of said substrate;
C. applying at least one layer of a finish composition comprising at least one fluorocarbon resin on said layer of primer composition; then
D. curing of the whole the applied layers of steps B. and C. at a temperature ranging from 370° C. to 430° C.

12. An item that can be obtained according to the method as defined according to claim 11.

13. The item according to claim 12, constituting a cookware item, one of the sides of which constitutes an inside surface intended to be in contact with food put inside said item and the other side of which is a convex outer surface intended to be in contact with a heat source.

14. A method for the manufacture of an item, comprising the following steps:
A. providing a metal substrate having two opposite sides;
B. applying at least one layer of the primer composition as defined according to claim 8 on one of the sides of said substrate;
C. applying at least one layer of a finish composition comprising at least one fluorocarbon resin on said layer of primer composition; then
D. curing the applied layers of steps B. and C. at a temperature ranging from 370° C. to 430° C.

15. A method for the manufacture of an item, comprising the following steps:
A. providing a metal substrate having two opposite sides;
B. applying at least one layer of the primer composition as defined according to claim 9 on one of the sides of said substrate;
C. applying at least one layer of a finish composition comprising at least one fluorocarbon resin on said layer of primer composition; then
D. curing the applied layers of steps B. and C. at a temperature ranging from 370° C. to 430° C.

16. The composition according to claim 2, wherein the aminosilane is 3 aminopropyltriethoxysilane (APTES).

17. The composition according to claim 2, wherein the silazane is hexamethyldisilazane.

18. A non-stick coating primer composition, comprising an aqueous composition as defined according to claim 2 and a fluorocarbon resin dispersion.

19. A non-stick coating primer composition, comprising an aqueous composition as defined according to claim 3 and a fluorocarbon resin dispersion.

20. A non-stick coating primer composition, comprising an aqueous composition as defined according to claim 4 and a fluorocarbon resin dispersion.
